(19) United States
(12) Patent Application Publication
(10) Pub. No.: US 2026/0279080 A1
(43) Pub. Date: Sep. 17, 2026

(54) SYSTEM FOR RECOGNIZING MULTIMODAL OBJECT BASED ON ARTIFICIAL INTELLIGENCE AND AUTONOMOUS DRIVING SENSOR AND METHOD IMPLEMENTING SAME

(71) Applicants: Hyundai Motor Company, Seoul (KR); Kia Corporation, Seoul (KR)

(72) Inventor: Ju Hyeok RA, Hwaseong-Si (KR)

(21) Appl. No.: 19/335,555

(22) Filed: Sep. 22, 2025

(30) Foreign Application Priority Data
Mar. 13, 2025 (KR) 10-2025-0032848

(51) Int. Cl. G06V 20/70; G06T 7/20; G06V 20/58

(52) U.S. Cl. CPC G06V 20/70; G06T 7/20; G06V 20/58

(57) ABSTRACT

Disclosed are an apparatus for recognizing an object and a method thereof. The apparatus may store a plurality of data points, of a plurality of image frames, received from a sensor; recognize, based on the plurality of data points, a multi-label object in the surrounding environment of the vehicle; update, for each of the plurality of image frames, object tracking information; and determine, based on the object tracking information, a provisional state of the multi-label object. If the provisional state is dynamic, the apparatus may maintain a dynamic label of the multi-label object or replace a previously assigned label of the multi-label object with the dynamic label. If the provisional state is static, the apparatus may maintain a static label of the multi-label object or replace the previously assigned label of the multi-label object with the static label.

### CROSS-REFERENCE TO RELATED APPLICATION

This application claims the benefit of and priority to Korean Patent Application No. 10-2025-0032848, filed in the Korean Intellectual Property Office on Mar. 13, 2025, the entire contents of which are incorporated herein by reference.

### TECHNICAL FIELD

The present disclosure relates to autonomous vehicles, and more specifically to a system for recognizing an object.

### BACKGROUND

Various sensors and artificial intelligence (AI) technologies are used in autonomous driving functions of vehicles. For example, researches are actively being conducted on recognizing objects in front of a moving vehicle and determining or estimating the distance between the object and the vehicle. Algorithms are being developed for vehicles to respond to specific situations to ensure safety.

Accordingly, vehicle sensor technology has advanced, and high-performance sensors such as a light detection and ranging (lidar) device that recognizes the surrounding environment using laser beams, a radar with radio waves, an ultrasonic sensor, a fisheye camera capable of photographing 360-degree images, a multifocal lens, a global positioning system (GPS), and the like have been installed in vehicles.

By aggregating measurement results obtained from multiple sensors as described above, it may be possible to implement a so-called super sensor vehicle. In autonomous driving (or self-driving), the concept of a super sensor refers to a technology that aims to recognize the surrounding environment more accurately by combining measurements from various sensors, rather than relying on individual sensors, for the convenience and safety of driving. With the addition of information and communications technology (ICT) and cloud technology, the sensors required for autonomous driving and the AI algorithms related to them have become more sophisticated than ever before, not only targeting a single vehicle, but also remotely accumulating (e.g., receiving) data from numerous vehicle units (e.g., a fleet of vehicles) and training AI servers and databases to increase the confidence of vehicle sensor determination.

Among these different sensory types, the LiDAR sensor, which is used to recognize the external environment, may emit laser and measure the time taken for the laser to be reflected off surrounding objects as well as the intensity of the reflected laser, thereby recognizing various objects on the road during autonomous driving.

However, object recognition using autonomous driving sensors and AI algorithms may not always produce accurate information about the vehicle's surroundings. Despite the advancements in sensing performance and advancement of AI technology, there is still a need for a technology to more accurately recognize objects, especially determining whether objects are moving or stationary.

The matters described in this Background section are only for enhancement of understanding of the background of the disclosure, and should not be taken as acknowledgement that they correspond to prior art already known to those skilled in the art.

### SUMMARY

The present disclosure has been made to solve the above-mentioned problems occurring in at least some implementations while advantages achieved by those implementations are maintained intact.

An aspect of the present disclosure provides a system for recognizing an object by an artificial intelligence (AI) and an autonomous driving sensor, and more specifically, to provide a system and a method capable of recognizing a multi-label (multi-modal) object existing in a surrounding environment from a plurality of point data input from an autonomous driving sensor.

The technical problems to be solved by the present disclosure are not limited to the aforementioned problems, and any other technical problems not mentioned herein will be clearly understood from the following description by those skilled in the art to which the present disclosure pertains.

In order to solve all or at least part of the technical problems described above, one or more example embodiments of the present disclosure may be implemented in various aspects as follows.

According to one or more example embodiments of the present disclosure, an apparatus of a vehicle may include: a processor; and a memory storing at least one instruction. The at least one instruction may be configured, when executed by the processor communicating with the memory, to cause the apparatus to store a plurality of data points, of a plurality of image frames, received from a sensor. The plurality of image frames may represent a surrounding environment of the vehicle. The at least one instruction may be configured, when executed by the processor communicating with the memory, to further cause the apparatus to recognize, based on the plurality of data points, a multi-label object in the surrounding environment of the vehicle; and update, for each of the plurality of image frames, object tracking information. The object tracking information may include speed information of the multi-label object and movement distance information of the multi-label object. The at least one instruction may be configured, when executed by the processor communicating with the memory, to further cause the apparatus to determine, based on the speed information and the movement distance information, a provisional state of the multi-label object. The provisional state may be one of a dynamic state or a static state. The at least one instruction may be configured, when executed by the processor communicating with the memory, to further cause the apparatus to perform one of: based on the provisional state of the multi-label object being the dynamic state for at least a threshold number of frames of the plurality y of image frames, maintaining a dynamic label of the multi-label object or replacing a previously assigned label of the multi-label object with the dynamic label; based on the provisional state of the multi-label object being the static state for at least the threshold number of frames of the plurality of image frames, maintaining a static label of the multi-label object or replacing the previously assigned label of the multi-label object with the static label; or based on the provisional state of the multi-label object being one of the dynamic state or the static state for less than the threshold number of frames of the plurality of image frames, maintaining an unknown label of the multi-label object or determining whether to delete the dynamic label or the static label of the multi-label object.

The previously assigned label may be the unknown label.

The previously assigned label may be the dynamic label.

The previously assigned label may be the static label.

The previously assigned label may be applied to the multi-label object based on at least of: a reference maximum size, a reference minimum size, or a reference height of an object classification corresponding to the multi-label object.

The speed information may include at least one of: a current speed of the multi-label object, an average speed of the multi-label object, an instantaneous acceleration of the multi-label object, or a speed standard deviation of the multi-label object. The movement distance information may include at least one of: an average movement distance of the multi-label object per a specified time, a movement distance of the multi-label object within a specified number of image frames, or whether a movement direction of the multi-label object is consistent.

The at least one instruction may be configured, when executed by the processor communicating with the memory, to cause the apparatus to update the object tracking information by: determining a confidence value of the object tracking information; determining, based on the confidence value, a priority of new object tracking information; and updating, based on the priority of the new object tracking information, previous object tracking information stored in the memory with the new object tracking information.

The at least one instruction may be configured, when executed by the processor communicating with the memory, to cause the apparatus to update the object tracking information by: storing, based on the new object tracking information having a high priority relative to the previous object tracking information stored in the memory and based on the memory including an empty space for high priority object tracking information, the new object tracking information in the empty space of the memory.

The at least one instruction may be configured, when executed by the processor communicating with the memory, to cause the apparatus to update the object tracking information by: based on the new object tracking information having a high priority relative to the previous object tracking information stored in the memory and based on the memory lacking an empty space for high priority object tracking information, deleting low priority object tracking information stored in a first space of the memory and storing the new object tracking information in the first space of the memory.

The at least one instruction may be configured, when executed by the processor communicating with the memory, to further cause the apparatus to: store the updated object tracking information in the memory in a first-in, first-out (FIFO) order.

According to one or more example embodiments of the present disclosure, a method performed by an apparatus of a vehicle may include: obtaining, based on sensing data received from a sensor, a plurality of data points of a plurality of image frames. The plurality of image frames may represent a surrounding environment of the vehicle. The method may further include: recognizing, based on the plurality of data points, a multi-label object in the surrounding environment of the vehicle; and updating, for each of the plurality of image frames, object tracking information. The object tracking information may include speed information of the multi-label object and movement distance information of the multi-label object. The method may further include determining, based on the speed information and the movement distance information, a provisional state of the multi-label object. The provisional state may be one of a dynamic state or a static state. The method may further include performing one of: based on the provisional state of the multi-label object being the dynamic state for at least a threshold number of frames of the plurality of image frames, maintaining a dynamic label of the multi-label object or replacing a previously assigned label of the multi-label object with the dynamic label; based on the provisional state of the multi-label object being the static state for at least the threshold number of frames of the plurality of image frames, maintaining a static label of the multi-label object or replacing the previously assigned label of the multi-label object with the static label; or, based on the provisional state of the multi-label object being one of the dynamic state or the static state for less than the threshold number of frames of the plurality of image frames, maintaining an unknown label of the multi-label object or determining whether to delete the dynamic label or the static label of the multi-label object.

The previously assigned label may be the unknown label.

The previously assigned label may be the dynamic label.

The previously assigned label may be the static label.

The previously assigned label may be applied to the multi-label object based on at least of: a reference maximum size, a reference minimum size, or a reference height of an object classification corresponding to the multi-label object.

The speed information may include at least one of: a current speed of the multi-label object, an average speed of the multi-label object, an instantaneous acceleration of the multi-label object, or a speed standard deviation of the multi-label object. The movement distance information may include at least one of: an average movement distance of the multi-label object per a specified time, a movement distance of the multi-label object within a specified number of image frames, or whether a movement direction of the multi-label object is consistent.

Updating the object tracking information may include: determining a confidence value of the object tracking information; determining, based on the confidence value, a priority of new object tracking information; and updating, based on the priority of the new object tracking information, previous object tracking information stored in a memory.

Updating the object tracking information may include: storing, based on the new object tracking information having a high priority relative to the previous object tracking information stored in the memory and based on the memory including an empty space for high priority object tracking information, the new object tracking information in the empty space of the memory.

Updating the object tracking information may include: based on the new object tracking information having a high priority relative to the previous object tracking information stored in the memory and based on the memory lacking an empty space for high priority object tracking information, deleting low priority object tracking information stored in a first space of the memory and storing the new object tracking information in the first space of the memory.

The method may further include: storing, in a memory, the updated object tracking information in a first-in, first-out (FIFO) order.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an example system for automatically recognizing an object and controlling a vehicle for autonomous driving;

FIG. 2 is a flowchart illustrating an example algorithm for determining moving or stationary objects and managing an array for an omnidirectional multimodal fusion object;

FIGS. 3A, 3B, and 3C are flowcharts illustrating example algorithms for a process of determining a moving or stationary object for an omnidirectional multimodal fusion object;

FIG. 4 is a diagram illustrating an example process of determining confidence of a tracking target object;

FIG. 5 is a diagram illustrating an example process of managing an array for a moving/stationary or unknown object;

FIG. 6 is a diagram illustrating an example of a process of managing an array for a moving/stationary or unknown object;

FIG. 7 is a view illustrating an example of determining a moving/stationary object and managing an array; and

FIG. 8 is a block diagram illustrating a computing system for autonomous vehicle control and object recognition operations.

### DETAILED DESCRIPTION

Hereinafter, one or more example embodiments of the present disclosure will be described in detail with reference to the example drawings. In adding the reference numerals to the components of each drawing, it should be noted that the identical or equivalent component is specified by the identical numeral even when they are displayed on other drawings. Further, in describing the example embodiment(s) of the present disclosure, a detailed description of the related known configuration or function will be omitted when it is determined that it interferes with the understanding of the example embodiment(s) of the present disclosure.

In addition, terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure. For example, in the present disclosure, an object has virtually the same meaning as an object, and the expressions “object” and “subject” are arbitrarily used interchangeably in the present disclosure.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The term “unit” as used herein may refer to software, or hardware component such as Field-Programmable Gate Array (FPGA), Application Specific Integrated Circuit (ASIC), etc. However, “unit” is not limited to hardware and software. The “unit” may be configured to be stored in an addressable storage medium, or may be configured to execute one or more processors. The “unit” may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., AI-based tracking of multimodal objects) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., AI-based tracking of multimodal objects) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., AI-based tracking of multimodal objects) described herein.

Minimum risk maneuver (MRM) operation(s) may also be controlled, for example, based on one or more features (e.g., AI-based tracking of multimodal objects) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., AI-based tracking of multimodal objects) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., AI-based tracking of multimodal objects) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., AI-based tracking of multimodal objects) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging and/or disengaging an autonomous driving mode, etc.).

The vehicle that an autonomous driving system is actively controlling may be referred to as an ego vehicle, a host vehicle, or an autonomous vehicle. The ego vehicle may also be referred to as a self-driving car, an autonomous car (AC), a driverless car, a robotaxi, a robotic car, or a robo-car. The ego vehicle may be the vehicle that is equipped with the autonomous driving system. Alternatively, the autonomous driving system may control the ego vehicle, for example, from an external and/or remote device, such as a server. The ego vehicle can be partially or wholly controlled (e.g., piloted, driven, etc.) remotely by a remote human driver. A car that is ahead of the ego vehicle (e.g., in the same driving lane as the ego vehicle) may be referred to as a vehicle in front (e.g., a vehicle directly in front), a vehicle ahead (e.g., a vehicle directly ahead), a lead vehicle, a leading vehicle, or a preceding vehicle. A car that follows the ego vehicle (e.g., in the same driving lane as the ego vehicle) may be referred to as a car behind, a trailing vehicle, a following vehicle, or a succeeding vehicle. An adjacent vehicle may refer to any vehicle located in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle that is near the ego vehicle (e.g., within a threshold distance away from the ego vehicle). The target vehicle may be any vehicle that the autonomous driving system monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a vehicle in a different lane than the driving lane of the ego vehicle (e.g., a vehicle to the left, a vehicle to the right, a vehicle in a diagonal direction, etc.), and/or an adjacent vehicle (e.g., regardless of the distance from the ego vehicle and/or regardless of whether there are intervening vehicle(s) between the target vehicle and the ego vehicle). A target vehicle may also be referred to as a surrounding vehicle, a nearby vehicle, an external vehicle, another vehicle (other vehicles), and so forth.

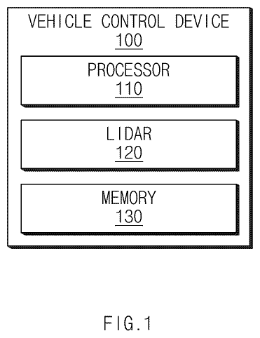

FIG. 1 is a block diagram illustrating an example system for automatically recognizing an object and controlling a vehicle for autonomous driving.

Referring to FIG. 1, a vehicle control device 100 may be implemented inside or outside a vehicle, and some of the components included in the vehicle control device 100 may be implemented inside or outside the vehicle. In this case, the vehicle control device 100 may be formed integrally with the internal control units of the vehicle, or may be implemented as a separate device and connected to the control units of the vehicle by a separate connection means. For example, the vehicle control device 100 may further include components not shown in FIG. 1.

The vehicle control device 100 may include a processor 110, a sensor (e.g., a light detection and ranging sensor (lidar)) 120, and a memory 130. The processor 110, the sensor 120, or the memory 130 may be electronically and/or operably coupled with each other by an electronic component including a communication bus.

Hereinafter, hardware being operably coupled may mean that a direct connection or an indirect connection between the hardware is established wired or wirelessly, such that second hardware is controlled by first hardware among the hardware.

Although illustrated in different blocks, the present disclosure is not limited thereto, and some of the hardware in FIG. 1 may be included in a single integrated circuit such as a system on chip (SoC). The type and/or number of hardware included in the vehicle control device 100 is not limited to that illustrated in FIG. 1. For example, the vehicle control device 100 may include only some of the hardware illustrated in FIG. 1.

The vehicle control device 100 may include hardware for processing data based on one or more instructions. For example, the hardware for processing data may include the processor 110. For example, the hardware for processing data may include an arithmetic and logic unit (ALU), a floating point unit (FPU), a field programmable gate array (FPGA), a central processing unit (CPU), a graphic processing unit (GPU), and/or an application processor (AP). The processor 110 may have a single-core processor structure, or may have the structure of a multi-core processor including dual cores, quad cores, hexa cores, or octa cores.

The processor 110 may include at least one of a graphic processing unit (GPU), a neural processing unit (NPU), or any combination thereof. For example, a GPU may be referred to as a visual processing unit (VPU). For example, an NPU may be referred to as a neural network processing unit.

The sensor 120 may be a depth sensor (also referred to as a proximity sensor or a distance sensor) for detecting an external object. For example, a depth sensor for detecting an external object may include at least one of a time-of-flight (ToF) sensor, the sensor 120, a structured light sensor, an ultrasonic sensor, an infrared sensor, a radio detection and ranging (radar), an optical distance sensor, or any combination thereof. Hereinafter, for convenience of explanation, the description will refer to the sensor 120 as a lidar, but the sensor 120 may be any other types of depth sensors.

The vehicle control device 100 may include the lidar 120 that obtains a plurality of points based on a pulse laser signal. For example, the lidar 120 may obtain data sets that identify objects surrounding the vehicle control device 100 (or a vehicle including the vehicle control device 100). For example, the lidar 120 may identify at least one of the position, direction of movement, speed, or any combination thereof of surrounding objects based on the pulse laser signal emitted from the lidar 120 being reflected back from surrounding objects.

For example, the lidar 120 may obtain data sets representing external objects in the space formed by the x-axis, y-axis, and z-axis based on pulse laser signals reflected from surrounding objects. For example, the lidar 120 may obtain data sets including a plurality of points in the space formed by the x-axis, the y-axis, and the z-axis based on receiving a pulse laser signal every specified time period. For example, the plurality of points may include points representing external objects within a three-dimensional virtual coordinate system. The 3D virtual coordinate system may include at least one of a vehicle coordinate system, a lidar coordinate system, or any combination thereof. However, examples of the 3D virtual coordinate system are not limited to those described above.

The memory 130 of the vehicle control device 100 may include a hardware component for storing data and/or instructions input and/or output to the processor 110. For example, the memory 130 may include a volatile memory including a random-access memory (RAM), and/or a non-volatile memory including a read-only memory (ROM).

For example, the volatile memory may include at least one of a dynamic RAM (DRAM), a static RAM (SRAM), a cache RAM, a pseudo SRAM (PSRAM), or any combination thereof. For example, the non-volatile memory may include at least one of a programmable ROM (PROM), an erasable PROM (EPROM), an electrically erasable PROM (EEPROM), a flash memory, a hard disk, a compact disc, a solid state drive (SSD), an embedded multi-media card (eMMC), or any combination thereof.

In the memory 130 of the vehicle control device 100, one or more instructions (or commands) indicating determinations (e.g., calculation) and/or operations to be performed by the processor 110 of the vehicle control device 100 with data may be stored. A set of one or more instructions may be referred to as a program, firmware, an operating system, a process, a routine, a sub-routine, and/or an application.

Hereinafter, the fact that an application is installed in the vehicle control device 100 may mean that one or more instructions provided in the form of an application are stored in the memory 130, and that one or more applications are stored in a format executable by the processor 110 of the vehicle control device 100 (e.g., a file having an extension specified by an operating system of the vehicle control device 100).

For example, the memory 130 may include a first neural network model for detecting an object. For example, the memory 130 may include a second neural network model for outputting the types of the plurality of points obtained by the lidar 120 and/or the scores of the plurality of points.

The processor 110 may obtain at least one of a first virtual box representing a target object, a first class representing a type of the target object, or a combination thereof, based on the plurality of points obtained through the lidar 120 and the first neural network model stored in the memory 130.

For example, the processor 110 may obtain at least one of a first virtual box representing a target object, a first class representing a type of the target object, or any combination thereof, based on inputting the plurality of points into the first neural network model. For example, the first neural network model may include an object detection model. For example, the target object may include an external object located within a specified distance from the vehicle control device 100 (or a host vehicle including the vehicle control device 100). For example, the target object may include an object that is identified by the vehicle control device 100 and is continuously tracked. For example, the type of a target object may include multiple types for classifying the target object. For example, the type of the target object may include at least one of a first type representing the ground, a second type representing a type different from the ground, or any combination thereof. However, the type of a target object is not limited to the above. For example, the type of a target object may include, at least one of a third type representing a person, a fourth type representing a vehicle, or any combination thereof, but is not limited thereto.

The processor 110 may obtain, based on the plurality of points and the second neural network model, at least one of first partial points corresponding to at least a part of the target object among the plurality of points, a second class identified through the first partial points and indicating the type of the target object, or any combination thereof. For example, the second neural network model may include a segmentation model.

For example, the second neural network model may include a neural network model for obtaining types of the plurality of points and scores of the plurality of points.

For example, the processor 110 may obtain first partial points corresponding to at least a portion of the target object among the plurality of points based on inputting the plurality of points into the second neural network model. For example, the processor 110 may identify the types of the plurality of points based on inputting the plurality of points into the second neural network model. For example, the processor 110 may obtain the first partial points corresponding to at least a portion of the target object from among the plurality of points based on the type of each of the plurality of points.

The processor 110 may perform a first specified algorithm for a plurality of points. For example, the processor 110 may perform the first specified algorithm for classifying a type of each of the plurality of points for a plurality of points. For example, the processor 110 may classify second partial points corresponding to a specified type among the plurality of points. For example, the specified type may include a type representing the ground.

For example, the processor 110 may classify the second partial points corresponding to a specified type based on performing the first specified algorithm on the plurality of points, and obtain (or identify) the first partial points by excluding the second partial points from among the plurality of points.

The processor 110 may obtain at least one of a partial class for obtaining a second class, a score of each of the plurality of points, or any combination thereof, based on inputting the plurality of points into the second neural network model. For example, the processor 110 may obtain a partial class and a score for each of the plurality of points based on inputting the plurality of points into the second neural network model. For example, the partial class may include a classification of each of the plurality of points into an arbitrary type.

For example, the processor 110 may fuse the partial class, the score of each of the plurality of points, and the second partial points. For example, the processor 110 may perform clustering based on the fusion of the partial class, the score of each of the plurality of points, and the second partial points. For example, clustering may include grouping the first partial points that correspond to at least part of a target object.

For example, the processor 110 may obtain a point cloud for generating a second virtual box based on the first partial points. For example, the processor 110 may obtain the point cloud based on grouping the first partial points.

For example, the processor 110 may generate a second virtual box for representing the target object, which is different from the first virtual box, based on the point cloud. For example, the second virtual box may include a box that includes at least some of the first partial points.

For example, the processor 110 may identify a heading direction indicating the moving direction of the target object based on at least one of the first partial points, the point cloud, or any combination thereof.

For example, the processor 110 may identify the position of the second virtual box in a virtual coordinate system based on at least one of the first partial points, the point cloud, or any combination thereof. For example, the processor 110 may identify the size of the second virtual box based on at least one of the first partial points, the point cloud, or any combination thereof. For example, the processor 110 may identify the second class based on at least one of the first partial points, the point cloud, or any combination thereof. For example, the processor 110 may identify at least one of the heading direction indicating the moving direction of a target object, the position of the second virtual box in the virtual coordinate system, the size of the second virtual box, the second class, or any combination thereof, based on at least one of the first partial points, the point cloud, or any combination thereof. For example, the processor 110 may identify the heading direction of the bounding box based on at least one of the first virtual box, the first class, the heading direction of the second virtual box, the position of the second virtual box, the size of the second virtual box, the second class, or any combination thereof. For example, the processor 110 may identify the position of the bounding box in the virtual coordinate system based on at least one of the first virtual box, the first class, the heading direction of the second virtual box, the position of the second virtual box, the size of the second virtual box, the second class, or any combination thereof. For example, the processor 110 may obtain a third class indicating the type of a target object corresponding to the bounding box based on at least one of the first virtual box, the first class, the heading direction of the second virtual box, the position of the second virtual box, the size of the second virtual box, the second class, or any combination thereof. For example, the processor 110 may obtain at least one of the heading direction of the bounding box, the position of the bounding box in the virtual coordinate system, the third class indicating the type of a target object corresponding to the bounding box, or any combination thereof, based on at least one of the first virtual box, the first class, the heading direction of the second virtual box, the position of the second virtual box, the size of the second virtual box, the second class, or any combination thereof.

For example, the processor 110 may assign a first identifier for tracking the second virtual box to the second virtual box. For example, the processor 110 may assign a second identifier corresponding to the first identifier to the bounding box.

For example, the processor 110 may track the bounding box by using the second identifier. For example, the processor 110 may track a target object based on identifying a plurality of bounding boxes including the bounding box to which the second identifier is assigned, in a plurality of frames (e.g., a plurality of frames of image data received from the sensor 120). For example, because the second identifier is an identifier assigned to the bounding box corresponding to the target object, the processor 110 may track the target object by identifying the plurality of bounding boxes to which the second identifier is assigned, in the plurality of frames (e.g., image frames).

The processor 110 may output the bounding box corresponding to the target object based on at least one of the first virtual box, the first class, the first partial points, the second class, or any combination thereof. For example, the bounding box may include an example of a target object represented in the virtual coordinate system in the form of a hexahedron.

Hereinafter, operations performed by a CPU, a GPU, and/or an NPU included in the processor 110 will be briefly described.

The processor 110 may include at least one of a CPU, a GPU, an NPU, or any combination thereof. For example, at least one of the GPU, the NPU, or any combination thereof may obtain the first virtual box and the first class based on the first neural network model. For example, at least one of the GPU and the NPU may obtain the first virtual box and the first class. For example, at least one of the GPU, the NPU, or any combination thereof may obtain the partial class for obtaining the second class and the score for each of the plurality of points based on the second neural network model. For example, at least one of the GPU and the NPU may obtain may obtain the partial class for obtaining the second class and the score for each of the plurality of points based on the second neural network model. For example, the CPU may classify second partial points among the plurality of points that correspond to a specified type, based on performing the first specified algorithm for classifying the type of each of the plurality of points for the plurality of points.

As described above, the vehicle control device 100 may include at least one processor 110. The vehicle control device 100 may accurately detect a target object by detecting the target object using at least one processor 110. In addition, by performing parallel processes, the vehicle control device 100 may reduce the load on each processor.

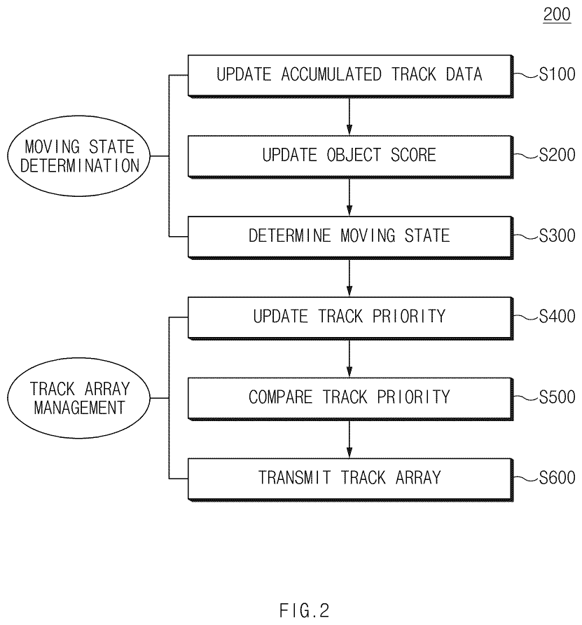

Meanwhile, before describing FIG. 2, for a general understanding of AI object recognition according to the present disclosure, a description related to LiDAR-based object recognition is added as follows.

The object recognition process by LiDAR 120 and AI module includes three operations: preprocessing, segmentation, and tracking.

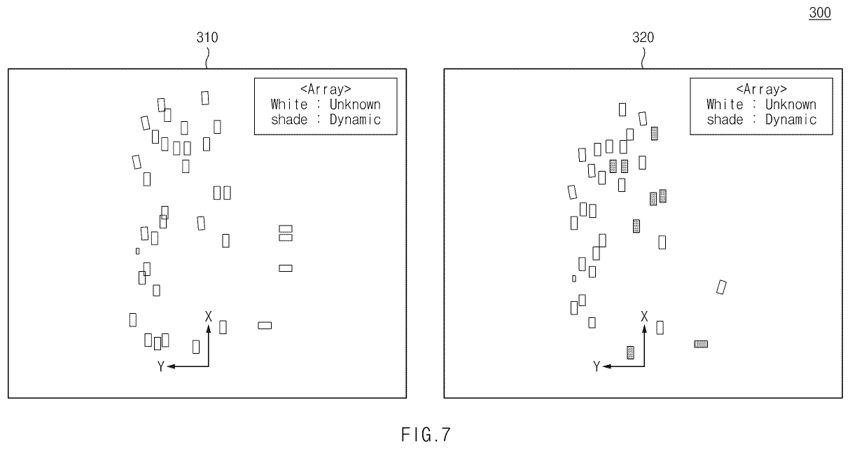

An object recognition system 1000 (see FIG. 7) according to the present disclosure performs a pre-processing process before executing an object recognition function. The preprocessing may include, for example, an operation of removing points forming the ground based on laser sensing data (e.g., unprocessed raw data) input from LiDAR 120. Because the laser beam reflected from the ground may be mistakenly recognized as an object on the ground, the process of distinguishing between the ground and non-ground is performed in a preprocessing operation, and when necessary, may also be performed in a segmentation operation.

In short, preprocessing in AI object recognition may be understood as a process in which an image processing tool of an AI module in the processor 110 removes noise from a LiDAR point cloud image and reduces the total number of points existing in the LiDAR point cloud image through, for example, a voxel down-sampling technique to improve computational efficiency.

For reference, the LiDAR point cloud image may also be displayed in a bird's eye view (BEV) manner. When a LiDAR map is created as if it was a bird's eye view of the city while flying in the sky, it is called a BEV image.

That is, as described above, the LiDAR 120 transmits a laser beam into a surrounding environment and records the time when the laser beam is reflected by an external object and returns, thereby generating a dot (e.g., a point) for each of numerous laser signals and determining (e.g., calculating) the distance to the point. By repeatedly transmitting a large number of laser beams in such a manner, the processor 110 may generate a real-time LiDAR map of the surrounding environment as a BEV type three-dimensional map, and as a two-dimensional map when necessary.

The lines or surfaces that appear in black and white on the LiDAR point cloud map are actually composed of countless points (each of which is generated by a laser beam of the LiDAR 120), and for this reason, the LiDAR sensing image is also called a LiDAR point cloud image. Of course, for example, by combining a red-green-blue-depth (RGB-D) sensor with a LiDAR sensor, the LiDAR point cloud image may be reconstructed in color.

Although it is difficult for humans to recognize objects with just one point in a LiDAR point cloud image, when we look at the point cloud comprehensively, such as from a BEV perspective or a two-dimensional plan, we may roughly guess what the surroundings of the vehicle currently driving autonomously look like. Furthermore, it is possible to recognize, for example, vehicles, buses, pedestrians, street trees, traffic signs, etc. existing in a LiDAR point cloud image. In AI image recognition technology, things or people may be called objects, and each object may be classified into a class that belongs to a group with specific characteristics, such as a vehicle class, a bus class, and the like.

In order to classify objects within a LiDAR point cloud image into car and bus classes, the help of a deep AI neural network is needed. In order to find objects in a LiDAR point cloud image and identify the classes of those objects using an AI neural network, AI training may be performed first.

For example, a dataset called PANDASET™ (source: https://pandaset.org/#data-collection) includes over 48,000 camera images (mostly taken in the Silicon Valley area in the United States) and over 16,000 LiDAR scan images, which are annotated with 28 classes in total, including pedestrians, vehicles, bicycles, construction site signs, traffic signs, and the like.

In addition, a LiDAR point cloud image may be visualized to suit the user's desired options by using a point cloud processing tool such as Open3D™ (source: https://www.open3d.org/). Because the LIDAR 120 is capable of distance detection, a 3D LiDAR image may be reproduced more realistically, for example, by displaying distant objects in dark blue and nearby objects in light blue during visual processing with Open3D™.

In addition, as described above, the original LiDAR image (e.g., raw data) may be preprocessed, for example, by applying a technique called voxel (3D pixel) down-sampling to the LiDAR point cloud image. In this case, a voxel refers to a 3D pixel in the shape of a cube, and voxel down-sampling is a technology that reduces the number of points so as not to require excessive AI calculations while maintaining the structure of various objects included in a LiDAR point cloud.

Meanwhile, the LiDAR 120 emits, for example, “m” laser beams “n” times during one scan cycle, and in this case, the scan values of the laser beams that return after colliding with an external object constitute an (m×n) matrix, and (m×n) matrix data is called a range image. Each point that constitutes a LiDAR point cloud image includes depth (e.g., range) information, as well as the intensity, azimuth, inclination, and other additional information of the returned laser pulse. For a range image, AI learning is possible with large datasets such as Waymo™ open dataset (WOD).

Range view (RV) is a technique that converts a 3D point cloud into a 2D or 2.5D scene, and expresses it as a LiDAR 3D map that humans intuitively understand, like an analog picture, instead of a large number of points. In a range view image, a 3D LiDAR point cloud image has 2D coordinates, but the 3D laser-related information (angle, inclination, intensity, etc.) recorded when obtaining the range image is not discarded. By applying a variable called a width to (x, y) coordinates among the (x, y, z) coordinate values of a 3D LiDAR image, the coordinate of one 2D axis is obtained, and by applying a variable called a height and range image information representing the range (depth) to the (z) coordinate, the coordinate of another 2D axis is obtained, which creates a 2D range view image.

In addition, an AI algorithm according to the present disclosure may include a convolutional neural network (CNN), which is an AI training module frequently used to extract features (or feature points) from image data. To this end, there are commercially available datasets including tens of thousands of images, and currently, there are CNN versions capable of processing images from one dimension to three dimensions. That is, the results of the range view image processing tool are used to train a CNN neural network and perform the function of helping AI accurately recognize objects in an image.

Because objects existing around an autonomous vehicle are ultimately recognized by a machine, an operation of generating a ground truth (GT) bounding box on the LiDAR map described above is also an important process in object recognition. In machine learning, ground truth (GT) is a term used to indicate an original or actual value of data that an AI is to learn. It may be understood as a type of image annotation applied to a LiDAR point cloud image, usually as a bounding box with a box-shaped boundary.

That is, in order to recognize objects, the AI module brings labels and groups various objects. Of course, the spacing of the 3D data points used to output the GT bounding box may be set to allow about 50 and 1000 LiDAR cloud points to be contained in one GT bounding box.

Of course, such GT annotations do not exist in the raw data captured by sensors such as the LiDAR 120 and the like while the vehicle drives. The processor 110 recognize objects belonging to various classes, such as road signs, crosswalks, pedestrians, other vehicles, and center lanes, as objects. GT annotation is a means used to measure an object recognition error and sometimes evaluate AI performance by comparing object determination results recognized by the AI algorithm of the processor 110 with reality. The GT bounding box, which is applied to the original image in the form of annotations, may be set manually by the user, but there are also commercially available GT calculation tools, such as Grid-striding.

Meanwhile, when driving the AI object recognition module, it is also possible to check the predicted bounding box. The result recognized by the processor 110 as an object of a specific class from the original image data obtained from the LiDAR sensor 120, and the like, appears in the form of another bounding box similar to the GT bounding box. Unlike GT bounding boxes, predicted bounding boxes are the result of computations by the autonomous driving AI. The predicted bounding box may coincide with the GT bounding box, but the predicted bounding box may not coincide with the GT bounding box or may not overlap with the GT bounding box at all.

For reference, because it is difficult to definitively determine that a specific class (e.g., classification or object classification) of object actually exists at a location based on predicted bounding boxes alone, the predicted bounding boxes are usually called probability boxes (P-Boxes).

Segmentation processing performed after preprocessing refers to, for example, displaying a specific part of a road (e.g., a traffic light) in red and the other parts (asphalt road) in blue. Clustering point clouds into specified groups and generating P-Boxes may also be performed at the segmentation operation. For reference, there is also a technology called cluster expansion, where the expansion target includes the cluster to all points within the distance of the seed point and epsilon (the minimum distance that constitutes the cluster).

Clustering and P-box generation based on a point cloud are performed during segmentation processing. In short, an AI network performing segmentation is used to obtain point labels from the LiDAR sensor 120.

In order to solve the problem of ground recognition errors occurring during segmentation, the present disclosure proposes a “rule-based” ground recognition and label fusion technique. Such a road surface recognition algorithm may apply any of a variety of techniques, including slope-based road surface recognition, grid-based road surface recognition, and other non-planar-based road surface recognition. However, the present disclosure proposes to adopt a slope-based road surface recognition technique when recognizing the road surface inside a tunnel.

For reference, semantic segmentation is the task of attaching a unique class label to each point in the point cloud generated by the LiDAR 120. In LiDAR image processing technology, semantic segmentation is a technology that finds and uses meaningful information from LiDAR data for object recognition and scene reproduction required for implementing autonomous driving. Various semantic segmentation AI models already exist, such as a projection-based method, a point-based method, a sparse convolution-based method, and the like. For example, the semantic segmentation result may be the result of an AI operation performed by the processor 110 with the NVIDIA DRIVER AGX system, and through such a configuration, for example, various colors may be added to a LiDAR point cloud image.

After the segmentation process as above, LiDAR images are treated through a process called post-processing. The post-processing refers to converting point cloud data into 3D maps or modeling, which are meaningful information for autonomous driving. The post-processing may also include the process of removing noise and errors from LiDAR point cloud images, recognizing objects such as vehicles or pedestrians from the point cloud, and, if necessary, attaching a unique identifier to the point cloud information to register it.

FIG. 2 is a flowchart illustrating an example algorithm for determining moving or stationary objects and managing an array for an omnidirectional multimodal fusion object.

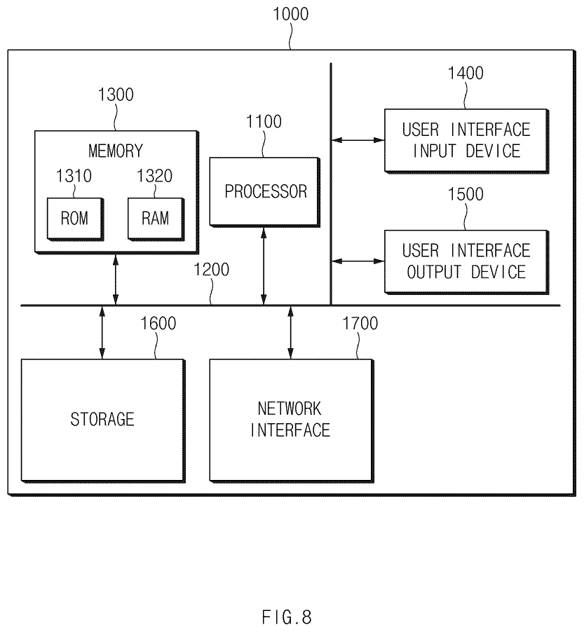

Referring to FIG. 2, first, in operation S100, the system 1000 (see FIG. 8) that recognizes an object by an AI module and an autonomous driving sensor updates tracking information (also referred to as track information or object tracking information or tracking history information for multi-modal objects) by the number (e.g., quantity) of accumulated frames (e.g., image frames) from the autonomous driving sensor (e.g., the sensor 120, such as a proximity sensor). That is, the system 1000 according to the present disclosure includes the processor 110 and the memory 130 in FIG. 1, and the processor 110 is equipped with an object recognition module as part of the AI module that recognizes a multi-label (multi-modal) object existing in the surrounding environment from the plurality of point data (also referred to as data points) that are input from the autonomous driving sensor 120.

Operation S100 is the first operation of determining a stationary or moving object according to the present disclosure by the AI module. Of course, the tracking information updated in operation S100 may include tens or hundreds of omnidirectional multimodal objects. In addition, because image data input from an autonomous driving sensor such as the LiDAR 120 may include frames (e.g., image frames) measured at regular time intervals, the number of frames of an object tracking image input (e.g., received) from the autonomous driving sensor 120 may accumulate over time, and the accumulated frames (e.g., image frames received over a period of time) may be stored in the memory 130.

For reference, in operation S100, the AI module may apply a first-in-first-out (FIFO) scheme when updating tracking information by the number of accumulated frames from the autonomous driving sensor and storing it in the memory.

That is, according to the present disclosure, data is accumulated in the memory 130 based on the so-called moving window. In the FIFO scheme, the oldest data among the accumulated data is deleted and the data storage array is moved one space at a time to update the data. Accordingly, the data at the current time point is stored in the last (most recent) array. It is also possible to convert past data accumulated in the memory 130 to current data by using the host-vehicle information at the current time point.

The data stored in the memory 130 in the FIFO scheme described above may include data input from an autonomous driving sensor 120 and features included in the data and expressed as following Equation 1 to Equation 4.

$$θ = Yawrate * Delta \qquad 〈 Equation 1 〉$$

$${x}_{dist} = {V}_{x} * Delta \qquad 〈 Equation 2 〉$$

$${y}_{dist} = {V}_{y} * Delta$$

$$Tv = [ \begin{matrix}{x}_{dist} \\ {y}_{dist}\end{matrix} ] + [ \begin{matrix}x \\ y\end{matrix} ] = [ \begin{matrix}x + {x}_{dist} \\ y + {y}_{dist}\end{matrix} ] \qquad 〈 Equation 3 〉$$

$$Rv = [ \begin{matrix}cos θ & - sin θ \\ sin θ & cos θ\end{matrix} ] [ \begin{matrix}x \\ y\end{matrix} ] = [ \begin{matrix}x cos θ & y sin θ \\ x sin θ & y cos θ\end{matrix} ] \qquad 〈 Equation 4 〉$$

where θ is a yaw angle of the vehicle, Vₓ is a longitudinal velocity of the vehicle, and V_{y} is a lateral velocity component of the vehicle. In addition, Delta is a time period at which new data is input from the autonomous driving sensor 120 (e.g., the difference between t−1 data and t data), and time point t corresponds to a current frame. Tv is a translation matrix and Rᵥ is a rotation matrix.

In operation S200, a dynamic score and/or a static score may be determined (e.g., calculated) based on the speed and movement distance information of the object extracted from the tracking information. The dynamic score of an object may indicate how likely the object is dynamic (e.g., in a motion state). The static score of an object may indicate how likely the object is static (e.g., in a stationary state). The dynamic and/or static score may, for example, be a numerical value (e.g., from 0 to 100) indicating how likely the object is either dynamic or static, respectively.

For example, according to the present disclosure, it is configured to determine whether an object is moving or stationary based on tracking information of up to a reference number of frames (e.g., 5 frames) accumulated (e.g., 5 most recent frames) in the memory 130. In this case, a shape-based reference may be applied, and for example, a scheme may be applied in which an object that exceeds a specified maximum or minimum size or height for each object class is determined as a static object. That is, it may be understood that the concept of a limit size for a movable object is applied.

In addition, in operation S200, as a detailed determination reference for dynamic objects, pedestrians and vehicles may be distinguished based on whether the current speed is, for example, outside a threshold range (e.g., the range of 4 kph to 10 kph), whether the average speed is above the threshold range (e.g., the range of 4 kph to 10 kph), whether the instantaneous acceleration is equal to or less than a threshold acceleration (e.g., 1 G), and/or whether the speed-related standard deviation is equal to or less than a threshold standard deviation value (e.g., the maximum standard deviation value of 1 G).

In addition, as another detailed determination reference of a dynamic object in operation S200, a vehicle and a pedestrian may be distinguished based on whether the average moving distance is outside a threshold range (e.g., the range of 0.1 m to 0.3 m) for a specified time period in terms of moving distance, and/or whether the object moves in a specified direction such as left, right, forward, or backward for a specified time period may be used as an additional determination reference.

Weights may be applied to each detailed item exemplified above in the speed condition or moving distance condition applied in operation S200 described above, and the result of summing weighted items may be determined as a dynamic score.

Furthermore, in operation S200, a detailed determination reference for a static object may be used, such as whether the current speed is 1 kph or less, whether the average speed is 1 kph or less, or the like. In addition, by using the moving distance, a detailed determination reference for a static object may be used, such as whether the average moving distance during a specified time interval is less than a threshold moving distance (e.g., 0.1 m at a speed of 4 kph), whether the total moving distance during a reference number of frames (e.g., 5 frames) is a threshold total moving distance (e.g., 0.5 m) or less, whether the moving direction is irregular, or the like. Of course, each of the detailed items for the static object determination may be given a different weight, and the sum of the weighted items may be determined (e.g., calculated) as a static score.

In operation S300, the dynamic and static scores determined (e.g., calculated) as described above in operation S200 are compared with each other or the determined (e.g., calculated) dynamic and static scores are compared with a reference value to provisionally determine whether the multi-label object is in a dynamic state (also referred to as a motion state or state of motion) or a static state (also referred to as a stationary state). Thereafter, when the provisionally determined dynamic or static state is maintained for a specified number of “N” frames or more, the determination of the dynamic or static state is completed.

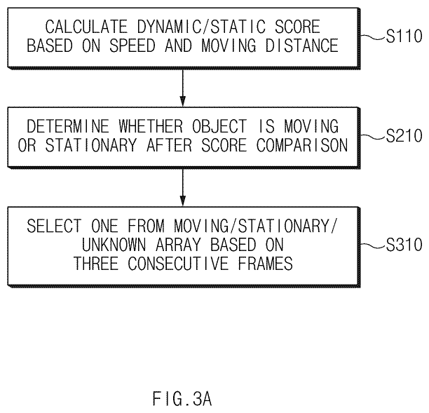

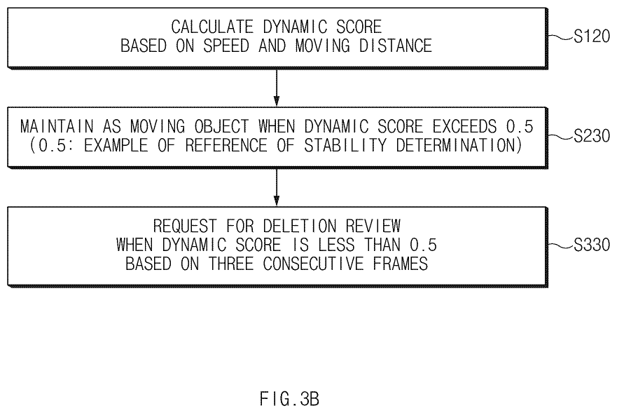

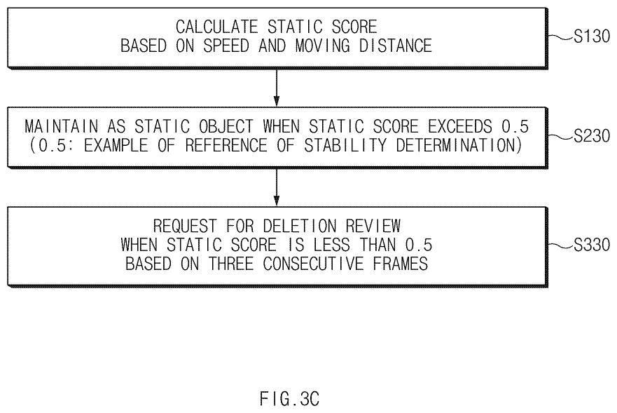

For operation S300, see additionally FIGS. 3A, 3B, and 3C. FIGS. 3A, 3B, and 3C are flowcharts illustrating example algorithms for a process of determining a moving or stationary object for an omnidirectional multimodal fusion object.

That is, according to the present disclosure, the array of objects is divided into three: Unknown, Dynamic, and Static. For the three arrays, a score suitable for the characteristics of each object type is determined (e.g., calculated) in operation S200. Then, based on the determined (e.g., calculated) score, it is determined whether the object has performance stable (e.g., whether the moving/stationary/unknown state is maintained for a specified number of frames or more), and for objects that maintain stable performance for a specified number of frames or more, it is determined whether to move the array (e.g., replace the array or label) as necessary.

Referring to FIG. 3A, in the case of an unknown object, a dynamic score and a static score are determined (e.g., calculated) based on the speed and the moving distance in operation S200 (e.g., operation S110 of FIG. 3A), and the two scores are compared to determine whether the object is in a moving or stationary state in operation S300 (e.g., operation S210 of FIG. 3A). For example, when it is determined that the object is in a moving or stationary state for three consecutive frames or more (e.g., operation S310 of FIG. 3A), the object is no longer an unknown object, and thus, an array label change in the memory 130 for the corresponding object is performed in operation S400 and below. When an object is not maintained in a moving or stationary state for three consecutive frames or more, the array label of the corresponding unknown object is still maintained as an unknown object.

Referring to FIG. 3B, in the case of a dynamic object, it is acceptable to determine (e.g., calculate) only the dynamic score based on the speed and moving distance in operation S200 (e.g., operation S120 of FIG. 3B). In operation S300 (e.g., operation S220 of FIG. 3B), it is determined whether the dynamic score has a confidence of, for example, 0.5 to 50% or more, and when the confidence is higher, the corresponding dynamic object is maintained as a dynamic object. However, when the dynamic score does not exceed the confidence reference (e.g., 0.5) for three consecutive frames or more (e.g., operation S320 of FIG. 3B), deletion of the dynamic array label is considered in operation S400 and below. For reference, although it does not exceed the confidence reference (e.g., 0.5), it is possible to continue to maintain the dynamic or static state label depending on whether it is determined to be a dynamic/static object based on the shape described above.

Referring to FIG. 3C, in the case of a static object, it is acceptable to determine (e.g., calculate) only the static score based on the speed and movement distance in operation S200 (e.g., operation S130 of FIG. 3C). In operation S300 (e.g., operation S230 of FIG. 3C), it is determined whether the static score has a confidence of, for example, 0.5 to 50% or more, and when the confidence is higher, the static object is maintained as a static object. However, when the static score does not exceed the confidence reference (e.g., 0.5) for three consecutive frames or more (e.g., operation S330 of FIG. 3C), deletion of the static array label is considered in operation S400 and below. For reference, although it does not exceed the confidence reference (e.g., 0.5), it is possible to continue to maintain the dynamic or static state label depending on whether it is determined to be a dynamic/static object based on the shape described above.

In short, in operation S300, when the provisionally determined dynamic state or static state is maintained for a specified number of “N” frames or more, a label already assigned to the multi-label object is maintained or replaced with a dynamic label or a static label. When the provisionally determined dynamic state or static state is not maintained for a specified number of “N” frames or more, an operation of maintaining the label already assigned to the multi-label object as an unknown label or determining whether to delete the dynamic label or the static label is performed.

Referring to FIG. 2 again, in operation S400, the system 1000 (see FIG. 8) that recognizes an object by an AI module and an autonomous driving sensor may determine (e.g., calculate) the confidence of the tracking information. In operation S500, based on the confidence (e.g., comparison of priorities), the system 100 may determine the priority of the tracking information to be stored in the memory among the tracking information. In operation S600, the tracking information and the multi-label information stored in the memory are updated according to the priorities.

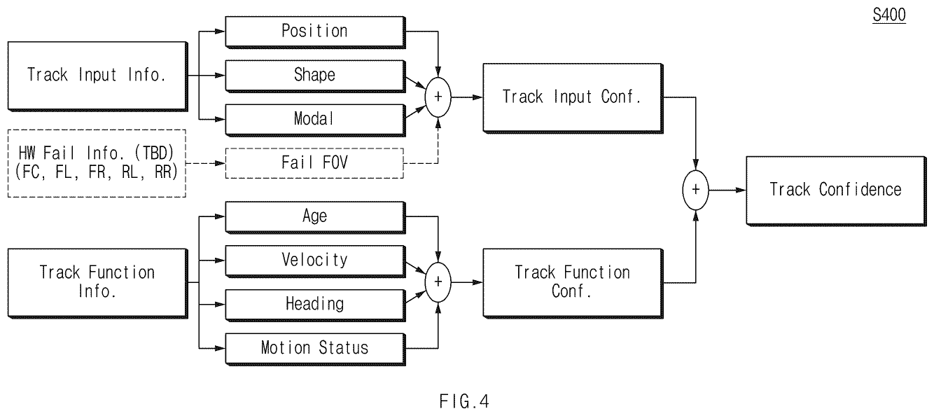

FIG. 4 is a diagram illustrating an example process of determining confidence of a tracking target object. That is, FIG. 4 is a part related to operation S400 of FIG. 2.

Referring to FIG. 4, track confidence (also referred to as a confidence value, a confidence score, a tracking confidence value, etc.) may be determined (e.g., calculated) for each tracking channel of the autonomous driving sensor 120, and as a confidence reference, the final confidence is determined (e.g., calculated) by synthesizing input information (e.g., Track Input Info), tracking function information (e.g., Track Function Info), hardware status information (e.g., HW Fail Info), and the like as shown in FIG. 4. In this case, In FIG. 4, the output range of the final confidence may be, for example, between 0 and 100.

The priority of the track is necessary for a strategy of storing a better tracking object in dynamic or static storage space (dynamic/static storage), for example, when the storage space of the memory 130 described above is full. Selection of comparison candidates (e.g., a low priority object) may be required for each dynamic or static storage space (dynamic/static storage), and in operation S500, the priority is determined based on the confidence shown in FIG. 4.

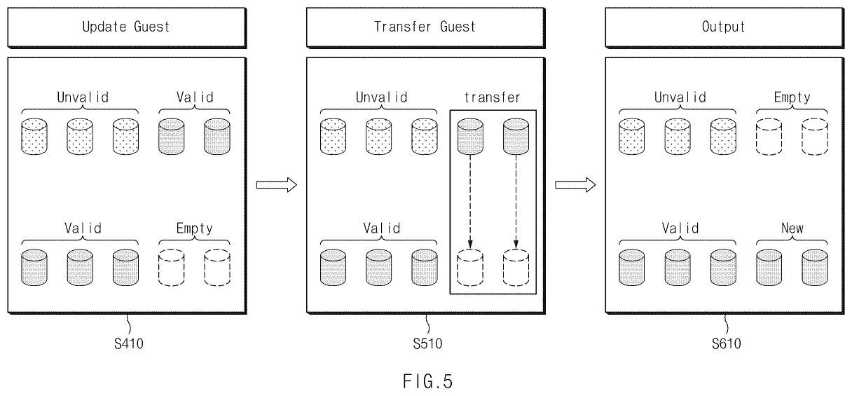

FIG. 5 is a diagram illustrating an example process of managing an array for a moving/stationary or unknown object. That is, as shown in FIG. 5, when there is an empty space when moving the array, a service request object may be allocated to the empty space.

That is, as shown in FIG. 5, when there is an empty space in the memory to store the tracking information and related multi-label information with a high priority, the AI module fills the empty space with the tracking information and related multi-label information with the high priority.

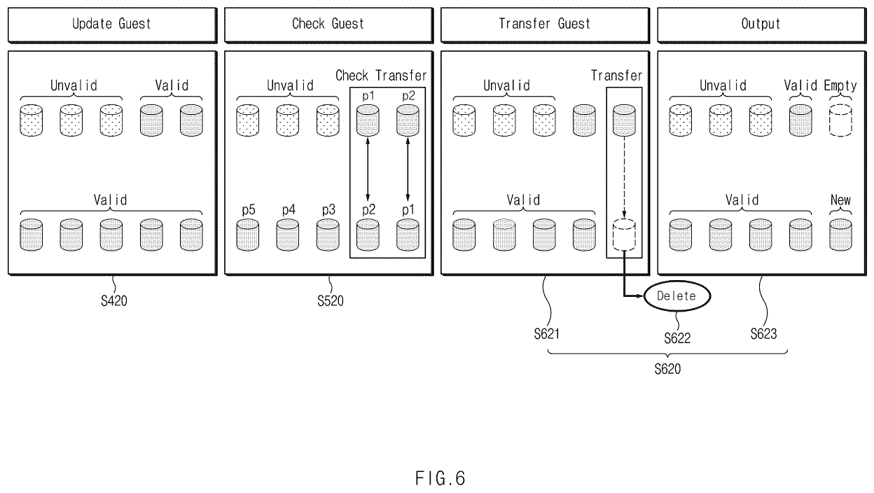

FIG. 6 is a diagram illustrating an example of the process of managing an array for a moving/stationary or unknown object.

As shown in FIG. 6, when there is no empty space in the memory to store the tracking information and the related multi-label information with a high priority, the AI module is configured to discard the tracking g information and the related multi-label information having a relatively low priority among the data stored in the memory and to fill the discarded space with the tracking information and the related multi-label information having a high priority.

That is, as shown in FIG. 6, when there is no empty space when moving an array, the confidence of the service object is compared with the object with the lowest priority in the array, and when the confidence of the service object is higher, the object to be moved is deleted and the service object is moved in its place.

FIG. 7 is a view illustrating an example 300 of determining a moving/stationary object and managing an array.

As indicated by reference numeral 310, when the array of objects is maintained as one, it is difficult to maintain a highly reliable output object. On the other hand, as indicated by reference numeral 320, according to the present disclosure, when the track and array are managed by separating the unknown array and the dynamic array, the moving/stationary object may be managed in a separate memory space with high confidence, and accordingly, the advantage of increased output stability of object tracking may be confirmed (yellow mark).

FIG. 8 is a block diagram illustrating a computing system 1000 for autonomous vehicle control and object recognition operations.

Referring to FIG. 8, the computing system 1000 may include at least one processor 1100, a memory 1300, a user interface input device 1400, a user interface output device 1500, storage 1600, and a network interface 1700 connected through a bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) and a random access memory (RAM).

Accordingly, the processes of the method or algorithm described herein may be implemented directly by hardware executed by the processor 1100, a software module, or a combination thereof. The software module may reside in a storage medium (that is, the memory 1300 and/or the storage 1600), such as a RAM memory, a flash memory, a ROM memory, an EPROM memory, an EEPROM memory, a register, a hard disk, solid state drive (SSD), a detachable disk, or a CD-ROM.

The example storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

According to the present disclosure, it is possible to determine moving/stationary objects based on tracking history information for an omnidirectional multi-modal fusion object, and recognize moving and stationary objects with high reliability by separating a tracking object array.

After determining the moving state of an object, the AI module inputs one of the multi-labels, such as moving, stationary, or unknown, to the object as a kind of annotation. According to the present disclosure, after storing track tracking information of, for example, up to five frames, the dynamic score or static score of an object is updated for multi-label assignment based on the stored tracking information. Then, the type and state of the object are determined based on each updated score, and an array of objects to be tracked is managed.

According to one aspect of the present disclosure, a system for recognizing an object through an artificial intelligence (AI) module and an autonomous driving sensor includes a processor including an object recognition module, as a part of the AI module, that recognizes a multi-label (multi-modal) object existing in a surrounding environment from a plurality of point data input from the autonomous driving sensor, and a memory that stores the plurality of point data input, wherein the AI module executes updating track information by a number of frames accumulated from the autonomous driving sensor, calculating a dynamic score and a static score based on speed and movement distance information of the object extracted from the track information, provisionally determining whether the multi-label object is in a dynamic state or a static state by comparing the calculated dynamic and static scores with each other or comparing the calculated dynamic and static scores with a reference value, and maintaining or replacing a label previously assigned to the multi-label object with a dynamic label or a static label when the provisionally determined dynamic state or static state is maintained for a specified number of N frames or more, and maintaining the label previously assigned to the multi-label object as an unknown label or determining whether to delete the dynamic label or the static label when the provisionally determined dynamic state or static state is not maintained for the specified number of N frames or more.

The previously assigned label may include the unknown label.

The previously assigned label may include the dynamic label.

The previously assigned label may include the static label.

The previously assigned label may be set by at least one reference among a maximum size, a minimum size or a height of a class of the object.

The speed information may include one of a current speed, an average speed, an instantaneous acceleration, or a speed standard deviation of the object, and the movement distance information includes an average movement distance of the object per a specified time, a movement distance within a specified number of frames, or whether a movement direction is consistent.

The AI module may further execute calculating confidence of the track information, determining a priority of the track information to be stored in the memory among the track information based on the confidence, and updating the track information and multi-label information stored in the memory according to the priority.

The AI module may execute filling an empty space with track information having high priority and related multi-label information when there is the empty space in the memory to store the track information having the high priority and the related multi-label information.

The AI module may execute discarding track information and related multi-label information having a relatively low priority among data stored in the memory, and filling a discarded space with track information and related multi-label information having a high priority when there is no free space in the memory to store the track information and related multi-label information having a high priority.

The AI module may further execute storing the updated track information in the memory in a first-in-first-out (FIFO) manner.

According to another aspect of the present disclosure, a method of recognizing and storing a multi-label (multi-modal) object in a memory, which exists in a surrounding environment from a plurality of point data input from an autonomous driving sensor and an artificial intelligence (AI) module, includes updating, by the AI module, track information by a number of frames accumulated from the autonomous driving sensor, calculating a dynamic score and a static score based on speed and movement distance information of the object extracted from the track information, provisionally determining whether the multi-label object is in a dynamic state or a static state by comparing the calculated dynamic and static scores with each other or comparing the calculated dynamic and static scores with a reference value, and maintaining or replacing a label previously assigned to the multi-label object with a dynamic label or a static label when the provisionally determined dynamic state or static state is maintained for a specified number of N frames or more, and maintaining the label previously assigned to the multi-label object as an unknown label or determining whether to delete the dynamic label or the static label when the provisionally determined dynamic state or static state is not maintained for the specified number of N frames or more.

According to the present disclosure, confidence information of a tracking object is updated and a priority within a confidence-based array is selected. The moving target of the unknown array is compared with the lower priority object in the static or dynamic array, and then, the object with higher confidence is allowed to move to the dynamic or static array.

According to the related art, whether moving or stationary is determined using tracking information in a single frame, but when tracking performance deteriorates, a determination error may occur, which causes problems in output performance.

That is, according to the present disclosure, because the number of omnidirectional objects may be, for example, up to 400 or more due to the sensor configuration, and the synthesized label information for each frame may be different for a single object, a movement or stop determination function based on tracking history is required, and it is necessary to increase output stability by maintaining and outputting objects with high importance based on tracking information from the past to the present.

Therefore, according to the present disclosure, it is possible to determine the movement state based on the tracking performance of multiple frames for an omnidirectional multi-label object to distinguish between moving objects and stationary objects. In order to output highly reliable moving objects, the output targets are maintained and output by separately dividing the memory storage space for moving objects and stationary objects.

In addition, through the detailed description of the present disclosure and the attached drawings, those skilled in the art will be able to understand various effects other than the effects described above from the present disclosure.

Although one or more example embodiments of the present disclosure have been described for illustrative purposes, those skilled in the art will appreciate that various modifications, additions and substitutions are possible, without departing from the scope and spirit of the disclosure.

Therefore, the example embodiment(s) disclosed in the present disclosure are provided for the sake of descriptions, not limiting the technical concepts of the present disclosure, and it should be understood that such example embodiment(s) are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus of a vehicle, the apparatus comprising:
a processor; and
a memory storing at least one instruction that is configured, when executed by the processor communicating with the memory, to cause the apparatus to:
store a plurality of data points, of a plurality of image frames, received from a sensor, wherein the plurality of image frames represent a surrounding environment of the vehicle;
recognize, based on the plurality of data points, a multi-label object in the surrounding environment of the vehicle;
update, for each of the plurality of image frames, object tracking information, wherein the object tracking information comprises speed information of the multi-label object and movement distance information of the multi-label object;
determine, based on the speed information and the movement distance information, a provisional state of the multi-label object, wherein the provisional state is one of a dynamic state or a static state; and
perform one of:
based on the provisional state of the multi-label object being the dynamic state for at least a threshold number of frames of the plurality of image frames, maintaining a dynamic label of the multi-label object or replacing a previously assigned label of the multi-label object with the dynamic label;
based on the provisional state of the multi-label object being the static state for at least the threshold number of frames of the plurality of image frames, maintaining a static label of the multi-label object or replacing the previously assigned label of the multi-label object with the static label; or
based on the provisional state of the multi-label object being one of the dynamic state or the static state for less than the threshold number of frames of the plurality of image frames, maintaining an unknown label of the multi-label object or determining whether to delete the dynamic label or the static label of the multi-label object.

2. The apparatus of claim 1, wherein the previously assigned label is the unknown label.

3. The apparatus of claim 1, wherein the previously assigned label is the dynamic label.

4. The apparatus of claim 1, wherein the previously assigned label is the static label.

5. The apparatus of claim 1, wherein the previously assigned label is applied to the multi-label object based on at least of: a reference maximum size, a reference minimum size, or a reference height of an object classification corresponding to the multi-label object.

6. The apparatus of claim 1, wherein the speed information comprises at least one of: a current speed of the multi-label object, an average speed of the multi-label object, an instantaneous acceleration of the multi-label object, or a speed standard deviation of the multi-label object, and
wherein the movement distance information comprises at least one of: an average movement distance of the multi-label object per a specified time, a movement distance of the multi-label object within a specified number of image frames, or whether a movement direction of the multi-label object is consistent.

7. The apparatus of claim 1, wherein the at least one instruction is configured, when executed by the processor communicating with the memory, to cause the apparatus to update the object tracking information by:
determining a confidence value of the object tracking information;
determining, based on the confidence value, a priority of new object tracking information; and
updating, based on the priority of the new object tracking information, previous object tracking information stored in the memory with the new object tracking information.

8. The apparatus of claim 7, wherein the at least one instruction is configured, when executed by the processor communicating with the memory, to cause the apparatus to update the object tracking information by:
storing, based on the new object tracking information having a high priority relative to the previous object tracking information stored in the memory and based on the memory comprising an empty space for high priority object tracking information, the new object tracking information in the empty space of the memory.

9. The apparatus of claim 7, wherein the at least one instruction is configured, when executed by the processor communicating with the memory, to cause the apparatus to update the object tracking information by:
based on the new object tracking information having a high priority relative to the previous object tracking information stored in the memory and based on the memory lacking an empty space for high priority object tracking information, deleting low priority object tracking information stored in a first space of the memory and storing the new object tracking information in the first space of the memory.

10. The apparatus of claim 1, wherein the at least one instruction is configured, when executed by the processor communicating with the memory, to further cause the apparatus to:
store the updated object tracking information in the memory in a first-in, first-out (FIFO) order.

11. A method performed by an apparatus of a vehicle, the method comprising:
obtaining, based on sensing data received from a sensor, a plurality of data points of a plurality of image frames, wherein the plurality of image frames represent a surrounding environment of the vehicle;
recognizing, based on the plurality of data points, a multi-label object in the surrounding environment of the vehicle;
updating, for each of the plurality of image frames, object tracking information, wherein the object tracking information comprises speed information of the multi-label object and movement distance information of the multi-label object;
determining, based on the speed information and the movement distance information, a provisional state of the multi-label object, wherein the provisional state is one of a dynamic state or a static state; and
performing one of:
based on the provisional state of the multi-label object being the dynamic state for at least a threshold number of frames of the plurality of image frames, maintaining a dynamic label of the multi-label object or replacing a previously assigned label of the multi-label object with the dynamic label;
based on the provisional state of the multi-label object being the static state for at least the threshold number of frames of the plurality of image frames, maintaining a static label of the multi-label object or replacing the previously assigned label of the multi-label object with the static label; or
based on the provisional state of the multi-label object being one of the dynamic state or the static state for less than the threshold number of frames of the plurality of image frames, maintaining an unknown label of the multi-label object or determining whether to delete the dynamic label or the static label of the multi-label object.

12. The method of claim 11, wherein the previously assigned label is the unknown label.

13. The method of claim 11, wherein the previously assigned label is the dynamic label.

14. The method of claim 11, wherein the previously assigned label is the static label.

15. The method of claim 11, wherein the previously assigned label is applied to the multi-label object based on at least of: a reference maximum size, a reference minimum size, or a reference height of an object classification corresponding to the multi-label object.

16. The method of claim 11, wherein the speed information comprises at least one of: a current speed of the multi-label object, an average speed of the multi-label object, an instantaneous acceleration of the multi-label object, or a speed standard deviation of the multi-label object, and
wherein the movement distance information comprises at least one of: an average movement distance of the multi-label object per a specified time, a movement distance of the multi-label object within a specified number of image frames, or whether a movement direction of the multi-label object is consistent.

17. The method of claim 11, wherein the updating of the object tracking information comprises:
determining a confidence value of the object tracking information;
determining, based on the confidence value, a priority of new object tracking information; and
updating, based on the priority of the new object tracking information, previous object tracking information stored in a memory.

18. The method of claim 17, wherein the updating of the object tracking information comprises:
storing, based on the new object tracking information having a high priority relative to the previous object tracking information stored in the memory and based on the memory comprising an empty space for high priority object tracking information, the new object tracking information in the empty space of the memory.

19. The method of claim 17, wherein the updating of the object tracking information comprises:
based on the new object tracking information having a high priority relative to the previous object tracking information stored in the memory and based on the memory lacking an empty space for high priority object tracking information, deleting low priority object tracking information stored in a first space of the memory and storing the new object tracking information in the first space of the memory.

20. The method of claim 11, further comprising:
storing, in a memory, the updated object tracking information in a first-in, first-out (FIFO) order.
